(19) United States
(12) Patent Application Publication
(10) Pub. No.: US 2011/0044730 A1
(43) Pub. Date: Feb. 24, 2011

(54) DEVELOPING DEVICE AND ELECTROPHOTOGRAPHIC IMAGE FORMING APPARATUS INCLUDING THE DEVELOPING DEVICE

(75) Inventors: Ki-Hwan KWON, Hwaseong-Si (KR); Soon-Cheol Kweon, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., SUWON-SI (KR)

(21) Appl. No.: 12/729,637

(22) Filed: Mar. 23, 2010

(30) Foreign Application Priority Data
Aug. 21, 2009 (KR) 10-2009-0077878

(51) Int. Cl. G03G 15/09

(52) U.S. Cl. 399/277

(57) ABSTRACT

A developing device and an electrophotographic image forming apparatus are disclosed. The developing device includes a ferromagnetic member arranged to cover at least partially the outer circumferences of two repulsive magnets of a developing roller so as to form a separating portion from which the developing agent remaining residual on the developing roller is released.

### CROSS-REFERENCE TO RELATED PATENT APPLICATION

This application claims the benefit of Korean Patent Application No. 10-2009-0077878, filed on Aug. 21, 2009, in the Korean Intellectual Property Office, the entire disclosure of which is incorporated herein by reference.

### TECHNICAL FIELD

The present disclosure relates generally to a developing device and an electrophotographic image forming apparatus including the developing device, and, more particularly, to a developing device having an improved developing agent separation characteristics, and to an electrophotographic image forming apparatus including the developing device.

### BACKGROUND OF RELATED ART

Electrophotographic image forming apparatuses print an image by forming an electrostatic latent image on an image carrier such as, for example, a photoconductive drum, and visualizing the electrostatic latent image using developing agent such as, for example, toner. Examples of such electrophotographic image forming apparatuses may include printers, photocopiers, facsimile machines, and the like.

Electrophotographic image forming apparatuses may be broadly classified into mono-component developing type electrophotographic image forming apparatuses and bi-component developing type electrophotographic image forming apparatuses. A mono-component developing type electrophotographic image forming apparatus employs developing agent that includes only the toner particles. A bi-component developing type electrophotographic image forming apparatus on the other hand employs a bi-component developing agent that includes both carrier and toner particles. A bi-component developing type electrophotographic image forming apparatus forms a toner image by applying toner, which is tribo-electrically charged by an agitator installed in its developing device, to an electrostatic latent image formed on the surface of an image carrier.

### SUMMARY OF DISCLOSURE

According to an aspect of the present disclosure, there is provided a developing device that may include a housing configured to contain therein developing agent, a developing sleeve and a magnetic force generator. The developing sleeve may be rotatably supported on the housing, and may be configured to supply the developing agent to, to thereby develop, an electrostatic latent image formed on an image carrier. The magnetic force generator may be disposed inside the developing sleeve, and may be configured to generate a magnetic flux distribution that defines a catching portion, a developing portion and a separating portion. The catching portion may attract the developing agent so that the developing agent adheres to the developing sleeve. The toner particles of the developing agent may be supplied from the developing portion so as to become adhered to the electrostatic latent image formed on the image carrier. The developing agent may be allowed to be released from the developing sleeve at the separating portion. The magnetic force generator may comprise a plurality of magnets and a ferromagnetic member. The plurality of magnets may comprise two repulsive magnets of the same magnetic polarity. The ferromagnetic member may form a magnetic path of at least a part of a magnetic flux generated from the two repulsive magnets. The ferromagnetic member and the two repulsive magnets may reduce the magnet flux density at at least a part of the separating portion.

The plurality of magnets may be arranged around an axial member. At least a part of the ferromagnetic member may be disposed between the two repulsive magnets. The ferromagnetic member may be connected to the axial member such that the at least a part of the magnetic flux generated from the two repulsive magnets flows through the ferromagnetic member to the axial member.

The ferromagnetic member may be formed of a soft magnetic material having a high permeability.

The ferromagnetic member may be formed of at least one material selected from the group consisting of pure iron, Fe—Cr stainless steel, Fe—Si alloy steel, Fe—Al alloy steel, Fe—Si—Al alloy steel, Ni—Fe permalloy and ferrite.

The developing device may further comprise a non-magnetic material disposed between the two repulsive magnets.

The ferromagnetic member may at least partially surround the non-magnetic member.

The non-magnetic member may be formed as an empty space, of an aluminum material, or of a plastic material.

The ferromagnetic member may at least partially cover one or both of outer circumferences of the two repulsive magnets.

The ferromagnetic member may have generally a U-shape, may have an arcuate portion, or may have a T-shape.

The plurality of magnets may be arranged to have magnetic poles of S1, N1, N2, S2 and N3 counter-clockwise from the separating portion. The ferromagnetic member may cover at least a portion of magnets of the magnetic poles N1 and N2.

The developing agent may comprise non-magnetic toner and magnetic carrier.

The developing agent may be a bi-component developing agent. The developing device may further comprise a supply roller and a mixing roller. The supply roller may be disposed in a lower portion of the housing, and may be configured to convey the developing agent to the developing sleeve. The mixing roller may be disposed in the housing, and may be configured to agitate the developing agent to thereby uniformly mix components of the bi-component developing agent.

According to another aspect of the present disclosure, there may be provided an electrophotographic image forming apparatus that may comprise an image carrier, an optical scanning unit and a developing unit. The optical scanning unit may be configured to scan light across a scanning surface of the image carrier to thereby form an electrostatic latent image on the scanning surface. The developing unit may be configured to supply toner to the electrostatic latent image formed on the image carrier to thereby develop the electrostatic latent image into visible image. The developing unit may comprise a housing configured to contain therein developing agent, a developing sleeve and a magnetic force generator. The developing sleeve may be rotatably supported on the housing, and may be configured to supply the developing agent to the electrostatic latent image. The magnetic force generator may be disposed inside the developing sleeve, and may be configured to generate a magnetic flux distribution that defines a catching portion, a developing portion and a separating portion. The catching portion may attract the developing agent so that the developing agent adheres to the developing sleeve. The toner particles of the developing agent may be supplied from the developing portion so as to become adhered to the electrostatic latent image formed on the image carrier. The developing agent may be allowed to be released from the developing sleeve at the separating portion. The magnetic force generator may comprise a plurality of magnets and a ferromagnetic member. The plurality of magnets may comprise two repulsive magnets of the same magnetic polarity. The ferromagnetic member may form a magnetic path of at least a part of a magnetic flux generated from the two repulsive magnets. The ferromagnetic member and the two repulsive magnets may reduce the magnet flux density at at least a part of the separating portion.

The plurality of magnets may be arranged around an axial member. At least a part of the ferromagnetic member may be disposed between the two repulsive magnets. The ferromagnetic member may be connected to the axial member such that the at least a part of the magnetic flux generated from the two repulsive magnets flows through the ferromagnetic member to the axial member.

The ferromagnetic member may be formed of a soft magnetic material having a high permeability.

the ferromagnetic member may be formed of at least one material selected from the group consisting of pure iron, Fe—Cr stainless steel, Fe—Si alloy steel, Fe—Al alloy steel, Fe—Si—Al alloy steel, Ni—Fe permalloy and ferrite.

The electrophotographic image forming apparatus may further comprise a non-magnetic material disposed between the two repulsive magnets.

The ferromagnetic member may at least partially surround the non-magnetic member.

The ferromagnetic member may at least partially cover one or both of outer circumferences of the two repulsive magnets.

The developing agent may comprise non-magnetic toner and magnetic carrier.

### BRIEF DESCRIPTION OF THE DRAWINGS

Various features and advantages of the present disclosure will become more apparent from the following description in detail of several embodiments thereof with reference to the attached drawings, in which:

FIG. 1 is a schematic view of the arrangement of a developing device according to an embodiment of the present disclosure;

FIG. 2 is a schematic perspective view of a developing roller according to an embodiment of the present disclosure employable in the developing device of FIG. 1;

FIG. 3 is a schematic partial cross-sectional perspective view of the developing roller of FIG. 2;

FIG. 4 is a schematic cross-sectional view of the developing roller of FIG. 2;

FIG. 5 illustrates a magnetic flux path near the separating portion in the developing roller of FIG. 2;

FIG. 6 is a graph of a distribution of a magnetic flux density on the surface of a developing sleeve according to an embodiment of the present disclosure;

FIG. 7 is a schematic partial cross-sectional perspective view of a developing roller according to another embodiment of the present disclosure;

FIG. 8 is a schematic partial cross-sectional perspective view of a developing roller according to another embodiment of the present disclosure;

FIG. 9 is a schematic perspective view of a developing roller according to another embodiment of the present disclosure;

FIG. 10 is a schematic perspective view of the developing roller of FIG. 9 partially disassembled;

FIG. 11 illustrates a magnetic flux path near the separating portion in the developing roller of FIG. 9;

FIG. 12 is a schematic partial cross-sectional perspective view of a developing roller according to another embodiment of the present disclosure; and

FIG. 13 is a schematic view illustrative of the configuration of an image forming apparatus according to an embodiment of the present disclosure.

### DETAILED DESCRIPTION OF SEVERAL EMBODIMENTS

Aspects of the present disclosure will now be described more fully with reference to the accompanying drawings, in which several embodiments of the present disclosure are illustrated. In the accompanying drawings, like reference numerals refer to like elements throughout, repetitive descriptions of which may be omitted. It should be also noted that in the drawings, the dimensions of the features are not intended to be to true scale and may be exaggerated for the sake of allowing greater understanding. While several embodiments are described with particular details in order to allow a full and comprehensive understanding of the aspects of the present disclosure, and to fully enable those skilled in the art to practice the same, it should be understood, however, that many modifications and variations are possible to the embodiments shown and described herein, and that the full scope of the present disclosure should not be construed as being limited by those embodiments described herein.

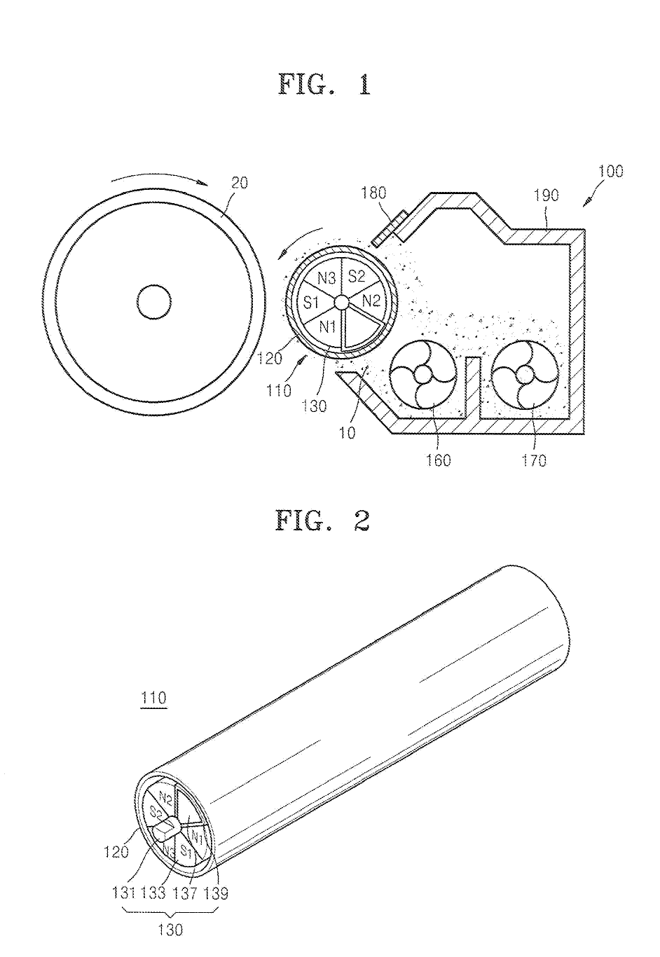

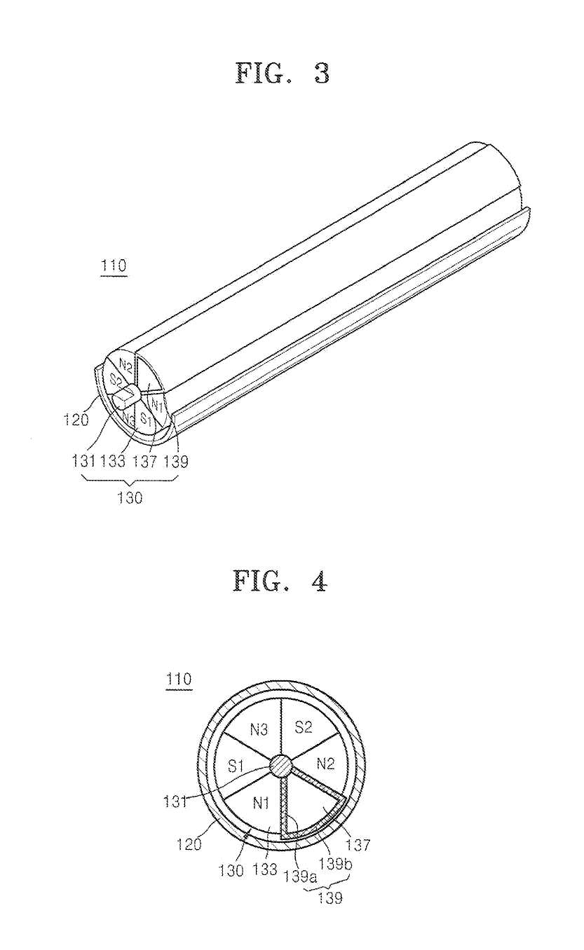

FIG. 1 is a schematic view illustrative of the arrangement of a developing device 100 according to an embodiment of the present disclosure. FIG. 2 is a schematic perspective view of the developing roller 110 according to an embodiment of the present disclosure that can be employed in the developing device 100 shown in FIG. 1. FIG. 3 is a schematic partial cross-sectional perspective view of the developing roller 110 according to an embodiment of the present invention. FIG. 4 is a schematic cross-sectional view of the developing roller 110.

Referring to FIG. 1, the developing device 100 according to an embodiment may includes the developing roller 110, a supply roller 160, a mixing roller 170, a regulating blade 180 and a housing 190 that supports therein or thereon the aforementioned components. The housing 190 may function as a container for the developing agent 10. The developing agent 10 used in the developing device 100 may be a bi-component developing agent that includes particles of non-magnetic toner and magnetic carrier. The magnetic carrier is used in conveying of the non-magnetic toner to the outer surface of an image carrier 20. The non-magnetic toner is used to develop an electrostatic latent image formed on the image carrier 20. The developing roller 110 transfers the developing agent 10 to develop the electrostatic latent image formed on the image carrier 20. To that end, the developing roller 110 may include a developing sleeve 120 that is rotatable and a magnetic force generator 130 that is formed inside the developing sleeve 120. The magnetic force generator 130 may be fixed on the housing 190. The supply roller 160 may be, for example, in a helical shape so as to be capable of moving the developing agent 10 toward the developing roller 110. A toner supplier (not shown) may supply toner of the developing agent 10 to the supply roller 160. The mixing roller 170 may be, for example, an agitating screw, blade or paddle, and agitate the developing agent 10 to thereby prevent the particles of the developing agent 10 from aggregating together into lumps while also frictionally charging the toner.

Referring to FIGS. 2 through 4, the magnetic force generator 130 may include an axial member 131, a plurality of magnets 133, a non-magnetic member 137 and a ferromagnetic member 139.

The axial member 131 may be formed of a ferromagnetic material, for example, a soft magnetic material having a high permeability, such as, for example, Fe—Cr stainless steel, Fe—Si alloy steel, Fe—Al alloy steel, Ni—Fe permalloy or ferrite, or the like.

The magnets 133 are arranged around the axial member 131 so that a magnetic flux is generated on an outer circumference of the developing sleeve 120. The distribution of the magnetic flux may define a catching portion, a regulating portion, a developing portion and a separating portion around the outer circumference of the developing sleeve 120. The magnetic flux near the catching portion pulls the developing agent 10 contained in the housing 190 to the outer circumference of the developing sleeve 120 and carries the developing agent 10 toward the image carrier 20. The magnetic flux near the developing portion adheres the toner of the developing agent 10 to the electrostatic latent image formed on the image carrier 20. The magnetic flux near the separating portion collects the residual developing agent 10 remaining on the outer circumference of the developing sleeve 120. The respective area of the catching portion, the regulating portion, the developing portion, and the separating portion or the magnetic flux distribution may vary according to the particular design of the developing device 100.

According to an embodiment, the magnetic force generator 130 may include five magnets 133. As illustrated, the five magnets 133 may be arranged to have magnetic poles of S1, N1, N2, S2 and N3 counter-clockwise about the axial member 131 to impart corresponding magnetic poles to the outer circumference thereof. For the purposes of descriptive convenience, the magnetic poles of S1, N1, N2, S2 and N3 may in appropriate context also refer to the corresponding magnets.

The magnetic pole N2 may be a catch pole that generates a magnetic force that attracts the developing agent 10 supplied by the supply roller 160. The distribution of the magnetic force generated by the catch pole N2 regulates the magnetic flux density of the catching portion on the developing sleeve 120.

The regulating blade 180 may be positioned to be spaced apart by a predetermined gap from the outer surface of the developing sleeve 120. As the developing sleeve 120 rotates, the developing agent 10 adhering to the developing sleeve 120 becomes thinned to a predetermined thickness by the regulating blade 180 at the regulating portion of the developing sleeve 120. The magnetic flux density at the boundary region between the magnetic poles N2 and S2 is regulated so as to facilitate the thinning of the developing agent 10 at the regulating portion.

The magnetic pole N3 may serve as the main developing pole that faces the image carrier 20 and that generates the magnetic force capable of developing the electrostatic latent image formed on the image carrier 20. The distribution of the magnetic force of the main developing pole regulates the magnetic flux density of the developing portion. The magnetic pole Si generates a magnetic force that allows the developing agent 10 that remains on the outer circumference of the developing sleeve 120 after the development of the electrostatic latent image to be carried back toward the housing 190.

The boundary between the magnetic pole N1 and the ferromagnetic member 139 and the boundary between the magnetic pole N2 and the ferromagnetic member 139 define therebetween the separating portion for separating the residual developing agent 10 remaining on the outer circumference of the developing sleeve 120 after the development of the electrostatic latent image on the image carrier 20 from the developing sleeve 120.

The non-magnetic member 137 is disposed between the magnet of the magnetic pole N1 and the magnet of the magnetic pole N2, and may be in the shape of a trapezoid, for example. The non-magnetic member 137 may be formed of, for example, an aluminum material or a non-magnetic plastic material, and may support the ferromagnetic member 139. Alternatively, the space surrounded by the ferromagnetic member 139 may be left as an empty space, i.e. the non-magnetic member 137 may be omitted in some embodiments.

The ferromagnetic member 139 may be formed of a ferromagnetic material having a high permeability, for example, at least one soft magnetic material selected from the group consisting of pure iron, Fe—Cr stainless steel, Fe—Si alloy steel, Fe—Al alloy steel, Fe—Si—Al alloy steel, Ni—Fe permalloy and ferrite. The soft magnetic materials can function as a magnetic path of a magnetic flux according to the high permeability thereof.

The ferromagnetic member 139 may include a first region 139a disposed at the boundary between the magnet of the magnetic pole N1 and the non-magnetic member 137 and at the boundary between the magnet of the magnetic pole N2 and the non-magnetic member 137 and a second region 139b that covers an outer circumference of the non-magnetic member 137, and may have a generally U-shaped cross section. The second region 139b attracts lines of magnetic force from the magnetic poles N1 and N2. The first region 139a magnetically connects the second region 139b and the axial member 131.

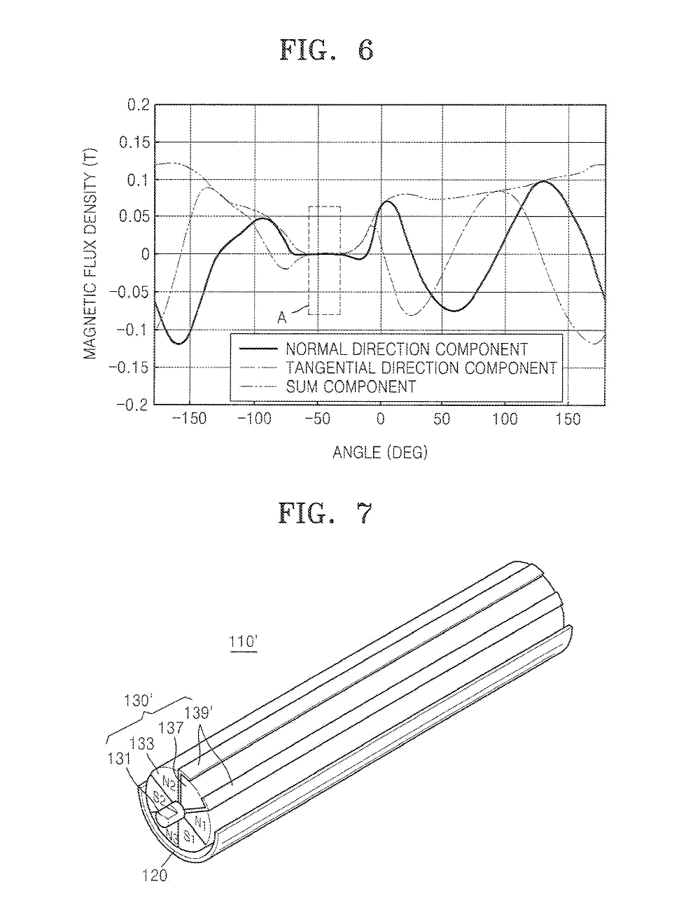

The separating portion is a region between the magnetic poles N1 and N2. As the two adjacent magnets N1 and N2 have the same magnetic poles, the magnetic forces of the two magnets are repulsive to each other so that the magnetic flux density is reduced in the region between the magnetic poles N1 and N2. According to an embodiment of the present disclosure, the ferromagnetic member 139 is provided in the region between the magnetic poles N1 and N2 so that the ferromagnetic member 139 attracts the magnetic force of the magnetic poles N1 and N2, thereby further reducing the magnetic flux density at the portion of the outer circumference of the developing sleeve 120 corresponding to the separating portion. The region of reduced magnetic flux density may be adjusted by adjusting the size of the second region 139b of the ferromagnetic member 139, and may be set to have a wide angle, for example, 40 degrees, as shown in FIG. 6. According to an embodiment, the ferromagnetic member 139 is disposed between the magnetic poles N1 and N2 to thereby prevent the magnetic flux density of the catching portion from being affected by the repulsive force between the magnetic poles N1 and N2, making it easier to design the magnetic pole N2 forming the catch pole.

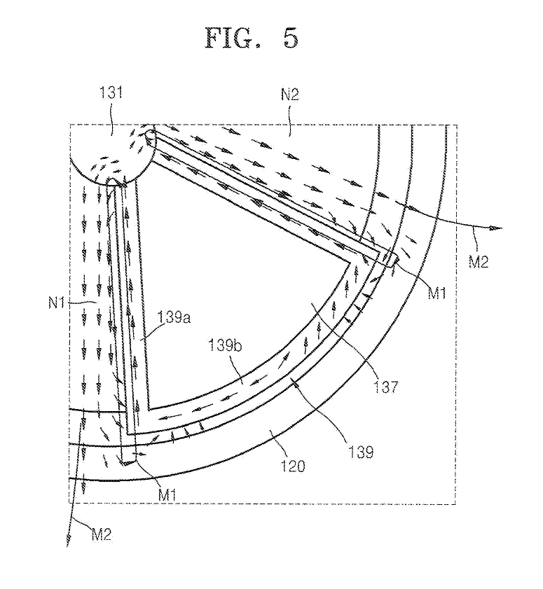

FIG. 5 illustrates the magnetic flux path near the separating portion of the developing roller 110 according to an embodiment of the present disclosure. Referring to FIG. 5, the magnetic poles N1 and N2 are provided to extend from the inner circumference to the outer circumference of the developing roller 110. Magnetic flux flows in the outer circumferences of the magnetic poles N1 and N2. However, the magnetic flux M1 of the magnetic poles N1 and N2 at the region adjacent the ferromagnetic member 139 is attracted by the ferromagnetic member 139 due to the high permeability of the ferromagnetic member 139. The magnetic flux M1 flows toward the axial member 131 through the first region 139a. The ferromagnetic member 139 thus forms a magnetic circuit.

Meanwhile, two magnetic fluxes M2 at the respective regions of the magnetic poles N1 and N2 that are sufficiently away from the ferromagnetic member 139 move away from each other due to the repulsive force between the magnetic poles N1 and N2 of the same polarity.

The magnetic poles N1 and N2 having the same polarity and the ferromagnetic member 139 remove the magnetic flux density at at least a part of the separating portion of the outer circumference of the developing sleeve 120.

FIG. 6 is a graph of the distribution of the magnetic flux density on the surface of the developing sleeve 120 according to an embodiment of the present disclosure. Referring to FIG. 6, a separating portion A that can be defined as a region between the magnetic poles N1 and N2 shows that the magnetic flux component in the normal direction and the magnetic flux component in the tangential direction approaches 0. As the magnetic flux density is close to zero at, the developing agent 10 that remains in the developing sleeve 120 can be separated from the surface of the developing sleeve 120 at the separating portion.

The operation of the developing device 100 of the present embodiment will now be described.

Referring to FIGS. 1 through 4, when the developing agent 10 is supplied by the supply roller 160 and when it is agitated by the mixing roller 170, the toner is charged by the frictional collusions between the carrier and the toner particles. With the toner particles so charged, the developing agent 10 is then supplied to the developing roller 110. The developing agent 10 adheres to the outer circumference of the developing sleeve 120 of the developing roller 110 in a brush state by a magnetic force generated from the magnetic pole N2. As the developing sleeve 120 rotates, the developing agent 10 adhering on the outer circumferential surface of the developing sleeve 120 is thinned to a predetermined thickness by the regulating blade 180. The developing agent 10 is then transferred from the developing roller to the image carrier 20. During the transfer, the toner of the developing agent 10 selectively adheres to, and thus develops, the electrostatic latent image formed on the image carrier 20 according to the magnetic field generated in the magnetic pole N3 which is the main developing magnetic pole. After the development of the electrostatic latent image, there may be regions of the developing sleeve 120 where the toner of the developing agent 10 did not transfer onto the image carrier 20, and thus remain residual on the outer circumference of the developing sleeve 120. Such residual developing agent 10 is carried by the rotation of the developing sleeve 120 inside the housing 190 of the developing device 100, and becomes separated from the developing sleeve 120 at the separating portion that has substantially no magnetic flux density. In this regard, the ferromagnetic member 139 of the developing device 100 according to an embodiment of the present disclosure can effectively reduce the magnetic flux density of the separating portion, thereby allowing an easier separation of the developing agent 10 from the developing sleeve 120. The efficient separation of the residual developing agent 10 may effectively reduce the hysteresis effects that may occur during consecutive development operations.

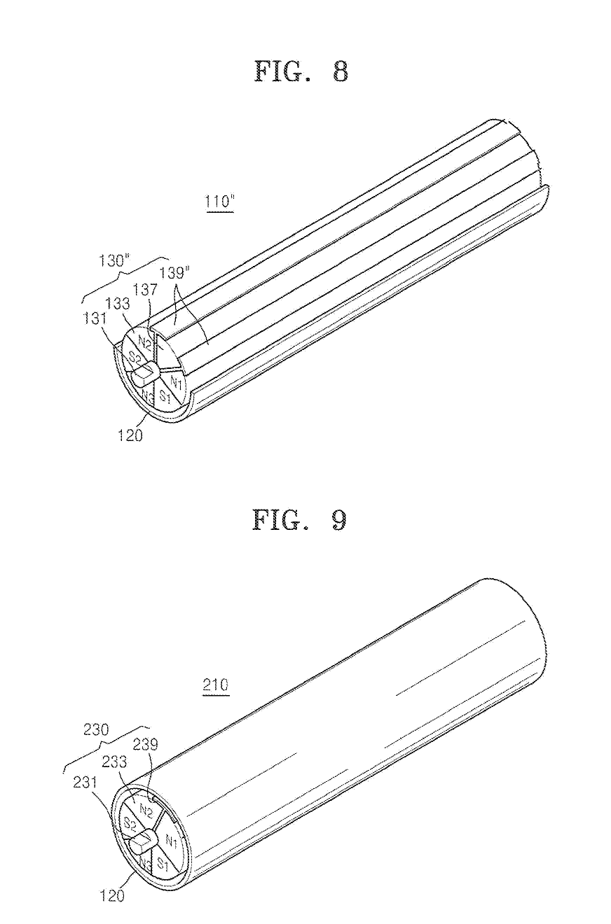

The ferromagnetic member 139 according to embodiments of the present disclosure may have various shapes as illustrated in FIGS. 7 and 8.

FIG. 7 is a schematic partial cross-sectional perspective view of a developing roller 110′ according to another embodiment of the present disclosure. Referring to FIG. 7, the developing roller 110′ is different from the developing roller 110 described earlier at least in that a portion of the outer circumference of the ferromagnetic member 139′ is removed along the axial direction. In the same manner as described with reference to FIG. 5, the ferromagnetic member 139′ attracts lines of magnetic force of the magnetic poles N1 and N2 that is adjacent to the ferromagnetic member 139′.

FIG. 8 is a schematic partial cross-sectional perspective view of the developing roller 110″ according to another embodiment of the present disclosure. Referring to FIG. 8, the developing roller 110″ is different from the developing roller 110 earlier at least in that a portion of the outer circumference of the ferromagnetic member 139″ is removed in the axial direction while the outer circumference of the ferromagnetic member 139″ extends further in the direction of the magnetic poles N1 and N2. According to an embodiment, the portion of the outer circumference of the ferromagnetic member 139″ that extend toward or over the magnetic poles N1 and N2, may be utilized for adjusting the size of the separating portion.

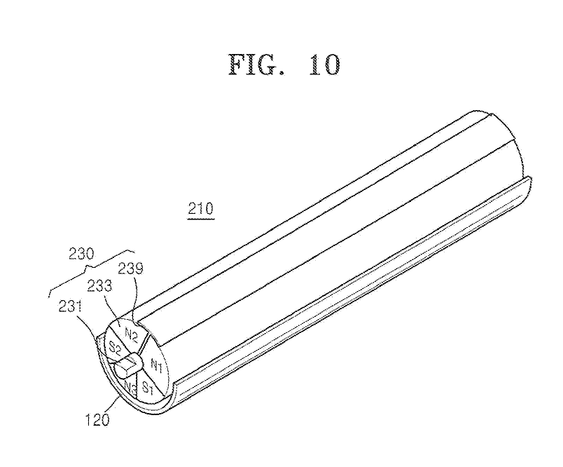

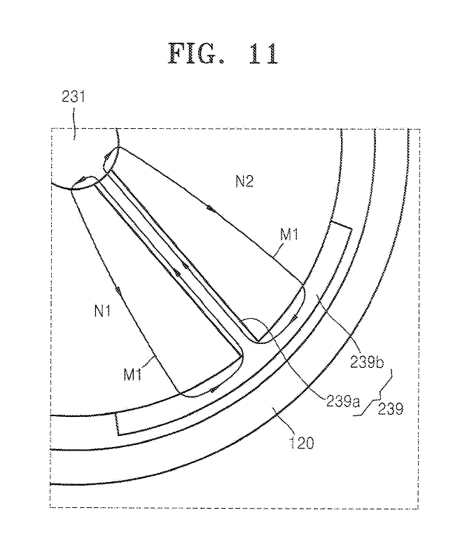

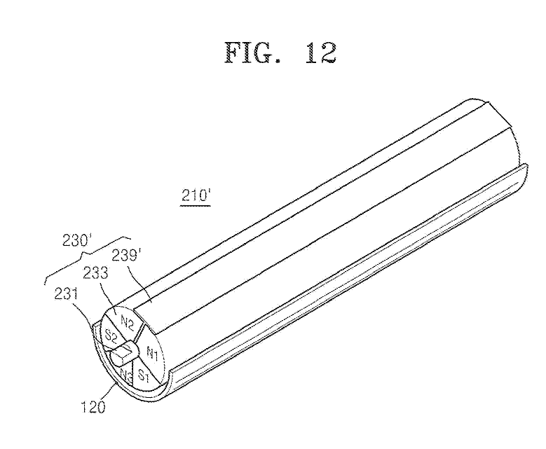

FIG. 9 is a schematic perspective view of a developing roller 210 according to another embodiment of the present disclosure. FIG. 10 is a schematic perspective view of the developing roller 210 of FIG. 9 with the developing sleeve 120 partially removed. FIG. 11 illustrates the magnetic flux path near the separating portion of the developing roller 210 of FIG. 9.

Referring to FIGS. 9 through 11, the developing roller 210 of the present embodiment includes the developing sleeve 120 and a magnet roller 230. The magnet roller 230 includes an axial member 231, a plurality of magnets 233 and a ferromagnetic member 239. The developing roller 210 may be the same as the developing roller 110 previously described except that the developing roller 210 does not include a non-magnetic member and that the shape of the ferromagnetic member 239 is different from the ferromagnetic member 139.

The magnets 233 may include two repulsive magnets corresponding to the magnetic poles N1 and N2 that placed adjacent each other. The ferromagnetic member 239 includes a first region 239a and a second region 239b. The first region 239a is disposed between the magnets of the magnetic poles N1 and N2, and magnetically connects the axial member 231 and the second region 239b. The second region 239b partially covers the magnetic poles N1 and N2. Referring to FIG. 11, the second region 239b attracts the magnetic flux from a partial region of the magnetic poles N1 and N2, and forms a closed loop magnetic circuit. Thus, the magnetic flux density of the partial regions of the magnetic poles N1 and N2 that are covered by the second region 239b is reduced to thereby form the separating portion.

According to an embodiment, as shown in FIGS. 9 through 11, the second region 139b of the ferromagnetic member 239 has an arcuate shape corresponding to the curvatures of The outer circumference of the regions of the magnetic poles N1 and N2 covered by the ferromagnetic member 239. However, the shape of the ferromagnetic member 239 is not necessarily limited to such an arcuate shape. For example, referring to FIG. 12, a ferromagnetic member 239′ of a developing roller 210′ may be T-shaped. In such an embodiment, the regions of the magnetic poles N1 and N2 covered by the ferromagnetic member 239′ may also be made substantially planar.

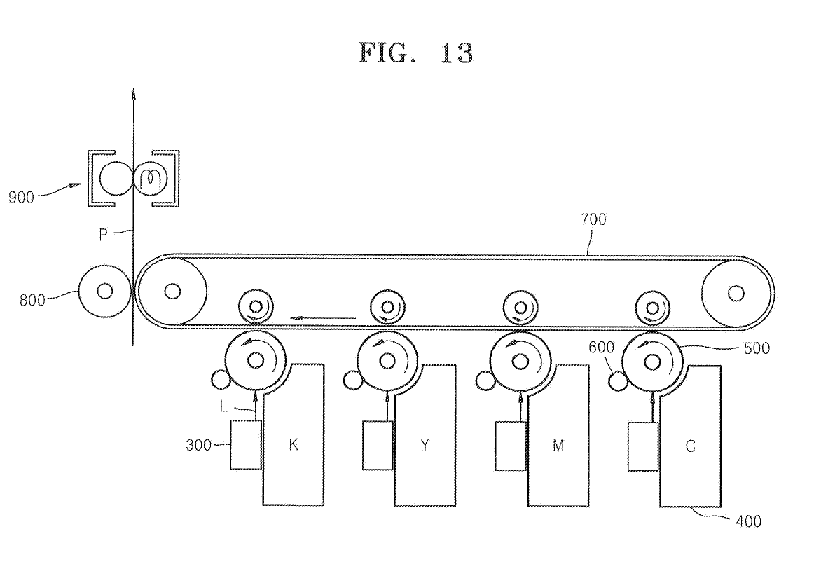

FIG. 13 is a schematic view of the configuration of an image forming apparatus according to an embodiment of the present disclosure. Referring to FIG. 13, the image forming apparatus according to an embodiment may include an optical scanning unit 300, a developing unit 400, an image carrier 500, a charging unit 600, an image transfer belt 700, a transfer roller 800 and a fixing unit 900.

The optical scanning unit 300 scans light L that is modulated according to image information onto the image carrier 500 along a main scanning direction. An electrostatic latent image according to the scanned light L may be formed on the image carrier 500, which may be, for example, a photoconductive drum that may include a photoconductive layer formed around an outer circumference of a cylindrical metal pipe. Alternatively, a photoconductive belt may be used as the image carrier 500. As the charging unit 600 rotates in contact with the image carrier 500 thereby charging the surface of the image carrier 500 to a uniform potential. The charging unit 600 may be, for example, a charging roller. A charging bias voltage Vc may be applied to the charging unit 600.

As previously described in detail, the developing unit 400 supplies toner to the image carrier 500, and thereby develops the electrostatic latent image formed thereon. Toner moves from the developing unit 400 to the image carrier 500 according to the developing bias voltage applied between the developing unit 400 and the image carrier 500, developing the electrostatic latent image into a visible toner image. The toner image so formed on the image carrier 500 is then transferred to the image transfer belt 700. The toner image is in turn transferred to a recording medium P such as, for example, a sheet of paper, as the recording medium P moves between the transfer roller 800 and the medium transfer belt 700 according to a transfer bias voltage applied to the transfer roller 800. Then, the toner image is fixed on the recording medium P by the application of heat and/or pressure from the fixing unit 900, completing the image formation operation.

Illustrated in FIG. 13 is an image forming apparatus capable of forming a color image that includes the optical scanning units 300, the developing units 400 and the image carriers 500 each corresponding in number to the number of colors of toner being used. That is, for example, the optical scanning unit 300 may scan four lights respectively to the four image carriers 500 so as to form four electrostatic latent images corresponding to image information about four colors of black K, magenta M, yellow Y and cyan C respectively on the four image carriers 500. The four developing units 400 supply toner of the black K, magenta M, yellow Y, and cyan C to the respective corresponding ones of the four image carriers 500, and thereby form toner images of the black K, magenta M, yellow Y and cyan C, which are transferred to the image transfer belt 700 overlapping one another to form a full color image. So formed color image is then transferred onto the recording medium P.

The developing device and the image forming apparatus including the developing device according to an aspect of the present disclosure is capable of efficiently separate the residual developing agent from the developing sleeve, is capable of thereby reducing the toner density variation due to the cumulative effects of the residual developing agent remaining on the developing sleeve over several consecutive image forming operations, and thus allows the electrostatic latent image on the image carrier to be developed into a toner image of a uniform density.

While the present disclosure has been particularly shown and described with reference to several embodiments thereof, it will be understood by those of ordinary skill in the art that various changes in form and details may be made to those embodiments described herein without departing from the spirit and scope of the present disclosure as defined by the following claims and their equivalents.

What is claimed is:

1. A developing device, comprising:
a housing configured to contain therein developing agent;
a developing sleeve rotatably supported on the housing, the developing sleeve being configured to supply the developing agent to, to thereby develop, an electrostatic latent image formed on an image carrier; and
a magnetic force generator disposed inside the developing sleeve, the magnetic force generator being configured to generate a magnetic flux distribution that defines a catching portion, a developing portion and a separating portion, the catching portion attracting the developing agent so that the developing agent adheres to the developing sleeve, toner particles of the developing agent being supplied from the developing portion so as to become adhered to the electrostatic latent image formed on the image carrier, the developing agent being allowed to be released from the developing sleeve at the separating portion,
wherein the magnetic force generator comprises a plurality of magnets and a ferromagnetic member, the plurality of magnets comprising two repulsive magnets of the same magnetic polarity, the ferromagnetic member forming a magnetic path of at least a part of a magnetic flux generated from the two repulsive magnets, and
wherein the ferromagnetic member and the two repulsive magnets reducing a magnet flux density at at least a part of the separating portion.

2. The developing device of claim 1, wherein the plurality of magnets are arranged around an axial member, and
wherein at least a part of the ferromagnetic member is disposed between the two repulsive magnets, the ferromagnetic member being connected to the axial member such that the at least a part of the magnetic flux generated from the two repulsive magnets flows through the ferromagnetic member to the axial member.

3. The developing device of claim 1, wherein the ferromagnetic member is formed of a soft magnetic material having a high permeability.

4. The developing device of claim 3, wherein the ferromagnetic member is formed of at least one material selected from the group consisting of pure iron, Fe—Cr stainless steel, Fe—Si alloy steel, Fe—Al alloy steel, Fe—Si—Al alloy steel, Ni—Fe permalloy and ferrite.

5. The developing device of claim 1, further comprising a non-magnetic material disposed between the two repulsive magnets.

6. The developing device of claim 5, wherein the ferromagnetic member at least partially surrounds the non-magnetic member.

7. The developing device of claim 5, wherein the non-magnetic member is formed as an empty space, of an aluminum material, or of a plastic material.

8. The developing device of claim 1, wherein the ferromagnetic member at least partially covers one or both of outer circumferences of the two repulsive magnets.

9. The developing device of claim 1, wherein the ferromagnetic member has generally a U-shape, has an arcuate portion, or has a T-shape.

10. The developing device of claim 1, wherein the plurality of magnets are arranged to have magnetic poles of S1, N1, N2, S2 and N3 counter-clockwise from the separating portion, and
wherein the ferromagnetic member covers at least a portion of magnets of the magnetic poles N1 and N2.

11. The developing device of claim 1, wherein the developing agent comprises non-magnetic toner and magnetic carrier.

12. The developing device of claim 1, wherein the developing agent is a bi-component developing agent, the developing device further comprising:
a supply roller disposed in a lower portion of the housing, the supply roller being configured to convey the developing agent to the developing sleeve; and
a mixing roller disposed in the housing, the mixing roller being configured to agitate the developing agent to thereby uniformly mix components of the bi-component developing agent.

13. An electrophotographic image forming apparatus, comprising:
an image carrier;
an optical scanning unit configured to scan light across a scanning surface of the image carrier to thereby form an electrostatic latent image on the scanning surface; and
a developing unit configured to supply toner to the electrostatic latent image formed on the image carrier to thereby develop the electrostatic latent image into visible image, the developing unit comprising:
a housing configured to contain therein developing agent;
a developing sleeve rotatably supported on the housing, the developing sleeve being configured to supply the developing agent to the electrostatic latent image; and
a magnetic force generator disposed inside the developing sleeve, the magnetic force generator being configured to generate a magnetic flux distribution that defines a catching portion, a developing portion and a separating portion, the catching portion attracting the developing agent so that the developing agent adheres to the developing sleeve, toner particles of the developing agent being supplied from the developing portion so as to become adhered to the electrostatic latent image formed on the image carrier, the developing agent being allowed to be released from the developing sleeve at the separating portion,
wherein the magnetic force generator comprises a plurality of magnets and a ferromagnetic member, the plurality of magnets comprising two repulsive magnets of the same magnetic polarity, the ferromagnetic member forming a magnetic path of at least a part of a magnetic flux generated from the two repulsive magnets, and
wherein the ferromagnetic member and the two repulsive magnets reducing a magnet flux density at at least a part of the separating portion.

14. The electrophotographic image forming apparatus of claim 13, wherein the plurality of magnets are arranged around an axial member, and
wherein at least a part of the ferromagnetic member is disposed between the two repulsive magnets, the ferromagnetic member being connected to the axial member such that the at least a part of the magnetic flux generated from the two repulsive magnets flows through the ferromagnetic member to the axial member.

15. The electrophotographic image forming apparatus of claim 13, wherein the ferromagnetic member is formed of a soft magnetic material having a high permeability.

16. The electrophotographic image forming apparatus of claim 15, wherein the ferromagnetic member is formed of at least one material selected from the group consisting of pure iron, Fe—Cr stainless steel, Fe—Si alloy steel, Fe—Al alloy steel, Fe—Si—Al alloy steel, Ni—Fe permalloy and ferrite.

17. The electrophotographic image forming apparatus of claim 13, further comprising a non-magnetic material disposed between the two repulsive magnets.

18. The electrophotographic image forming apparatus of claim 17, wherein the ferromagnetic member at least partially surrounds the non-magnetic member.

19. The electrophotographic image forming apparatus of claim 13, wherein the ferromagnetic member at least partially covers one or both of outer circumferences of the two repulsive magnets.

20. The electrophotographic image forming apparatus of claim 13, wherein the developing agent comprises non-magnetic toner and magnetic carrier.
